(19) United States
(12) Patent Application Publication
(10) Pub. No.: US 2008/0155835 A1
(43) Pub. Date: Jul. 3, 2008

(54) Flower shears

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/646,261

(22) Filed: Dec. 28, 2006

(51) Int. Cl. B26B 13/00

(52) U.S. Cl. 30/252

(57) ABSTRACT

A flower shears includes a stationary unit, a movable unit and a driving unit. The stationary unit has a first blade portion at an upper part thereof, a first transmission portion with teeth at a middle part thereof, and a first handle at a lower part thereof. The movable unit is pivotally connected at a middle part thereof to the stationary unit and provided at an upper part thereof with a second blade portion. The driving unit is pivotally connected to a bottom end of the movable unit and provided with a second handle at a lower part thereof and a second transmission portion with teeth meshed with the teeth of the first transmission portion, such that the second blade portion of the moveable unit can be driven by the second handle through the engagement of the teeth of the first and second transmission portions to pivotally move toward the first blade portion of the stationary unit for cutting things.

### BACKGROUND OF THE INVENTION

1. Field of the Invention

The present invention relates generally to a gardening implement and more specifically, to a flower shears that is laborsaving in operation.

2. Description of the Related Art

A conventional flower shears comprises two blades pivotally fastened to each other. The blades are respectively provided with a cutting edge and a handle. On the premise that the pivotal angle between the two blades is fixed, the cutting range of the flower shears will increase if the length of the cutting edge is longer than the length of the handle, but the flower shears is laborious in operation under this condition. On the contrary, the flower shears will be laborsaving in operation if the length of the cutting edge is shorter than the length of the handle; however, the cutting range of the flower shears under this condition will decrease.

Another conventional flower shears is provided with a spring member fastened between the two handles to provide a rebound force to return the handles from the closed position to the opened position when doing a scissors action for convenient use. However, the structure of this kind of the flower shears has the same structure as the above-mentioned conventional flower shears, so that this kind of the flower shears has the same deficient in operation that the above-mentioned conventional flower shears has.

### SUMMARY OF THE INVENTION

The present invention has been accomplished under the circumstances in view. It is therefore one objective of the present invention to provide a flower shears, which is laborsaving in operation.

To achieve this objective of the present invention, the flower shears comprises a stationary unit, a movable unit and a driving unit. The stationary unit is provided with a first blade portion at an upper part thereof, a first transmission portion at a middle part thereof, and a first handle at a lower part thereof. The movable unit has a middle part pivotally connected to the stationary unit, and an upper part defining a second blade portion. The driving unit is pivotally connected to a bottom end of the movable unit and provided with a second handle at a lower part thereof and a second transmission portion at a top end thereof movably engaged with the first transmission portion, such that the second blade portion of the moveable unit can be driven by the second handle through the engagement of first and second transmission portions to pivotally move toward the first blade portion of the stationary unit for cutting things. By means of the engagement of the first and second transmission portions, the cutting torque transmitted through the relative movement action of the engaged first and second transmission portions can be provided higher than the conventional flower shears, so that the flower shears of the present invention is laborsaving in operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of the flower shears according to a preferred embodiment of the present invention;

FIG. 2 is an exploded view of the flower shears according to the preferred embodiment of the present invention;

FIG. 3 is a schematic drawing showing a spring member of the flower shears according to the preferred embodiment of the present invention compressed;

FIG. 4 is another schematic drawing showing the spring member of the flower shears according to the preferred embodiment of the present invention extending; and

FIG. 5 is a schematic drawing showing that the limiter of the flower shears according to the preferred embodiment of the present invention is located at an engagement position.

### DETAILED DESCRIPTION OF THE INVENTION

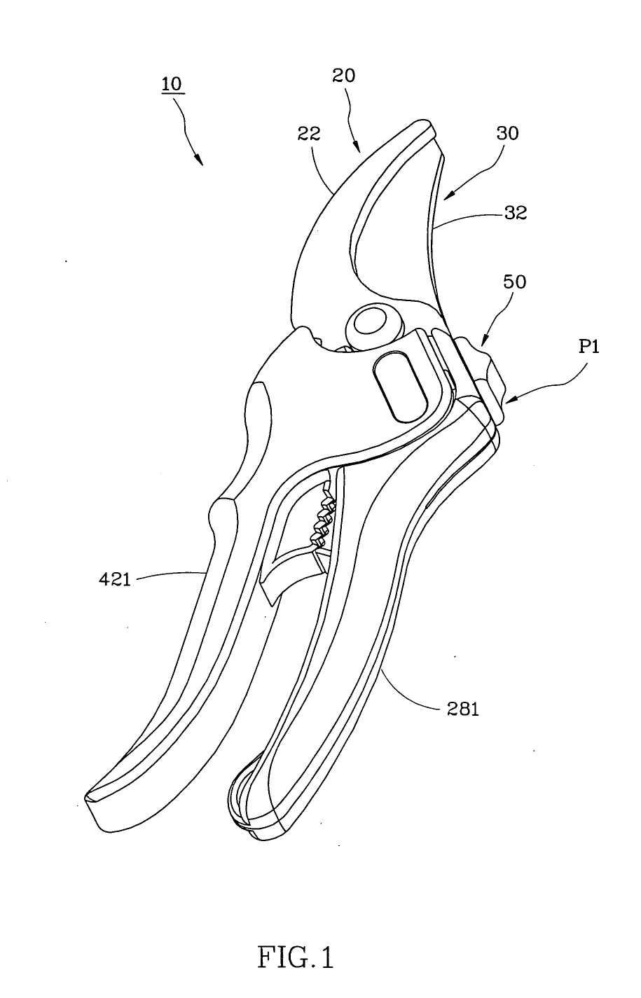

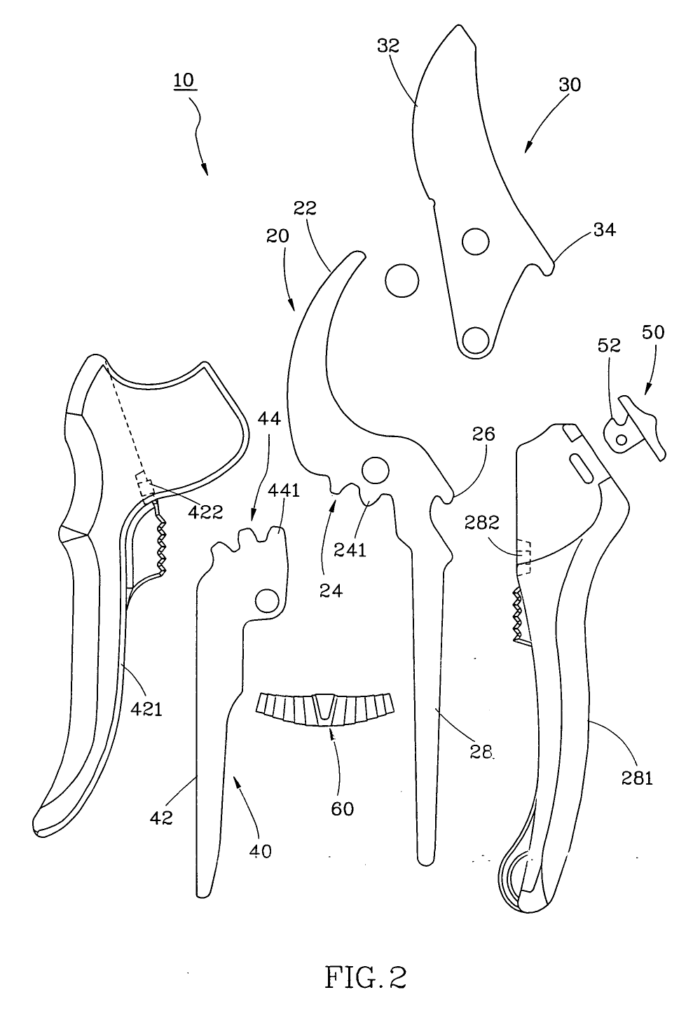

As shown in FIG. 1 and FIG. 2 a flower shears 10 in accordance with a preferred embodiment of the present invention comprises a stationary unit 20, a movable unit 30, a driving unit 40, a limiter 50 and a spring member 60.

The stationary unit 20 is provided with a first blade portion 28 at an upper part thereof, a transmission portion 24 at one lateral side of a middle part thereof, a first stop portion 26 at the other lateral side of the middle part thereof, and a first handle 28 at a lower part thereof. The transmission portion 24 has teeth 241 and the stationary unit 20 is covered at the middle and lower parts thereof with a sheath 281 for holding by a user. The sheath 281 is provided with a protrusion 282 located close to a middle part thereof.

The movable unit 30 is pivotally connected at a middle part thereof to the stationary unit 20 and provided with a second blade portion 32 at an upper part thereof and a second stop portion 34 at one lateral side of the lower part thereof.

The driving unit 40 is pivotally connected to a bottom end of the movable unit 30 and provided with a second handle 42 at a lower part thereof and a second transmission portion 44 at a top end thereof. The second handle 42 is covered with a sheath 421 for holding by the user. The sheath 421 is provided with a protrusion 422 located close to a middle part thereof and facing the protrusion 282 of the sheath 281 covered on the first handle 28. The second transmission portion 44 is provided with teeth 441 meshed with the teeth 241 of the first transmission portion 24 such that the second blade portion 32 of the moveable unit 30 can be driven by the second handle 42 through the engagement of the teeth 411 and 241 to move toward the first blade portion 22 of the stationary unit 20 for cutting things.

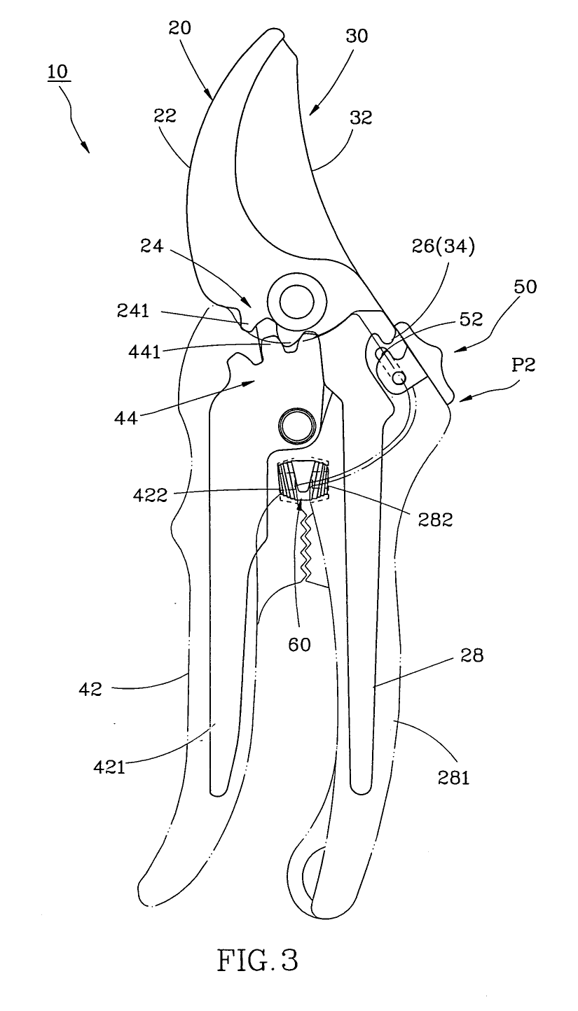

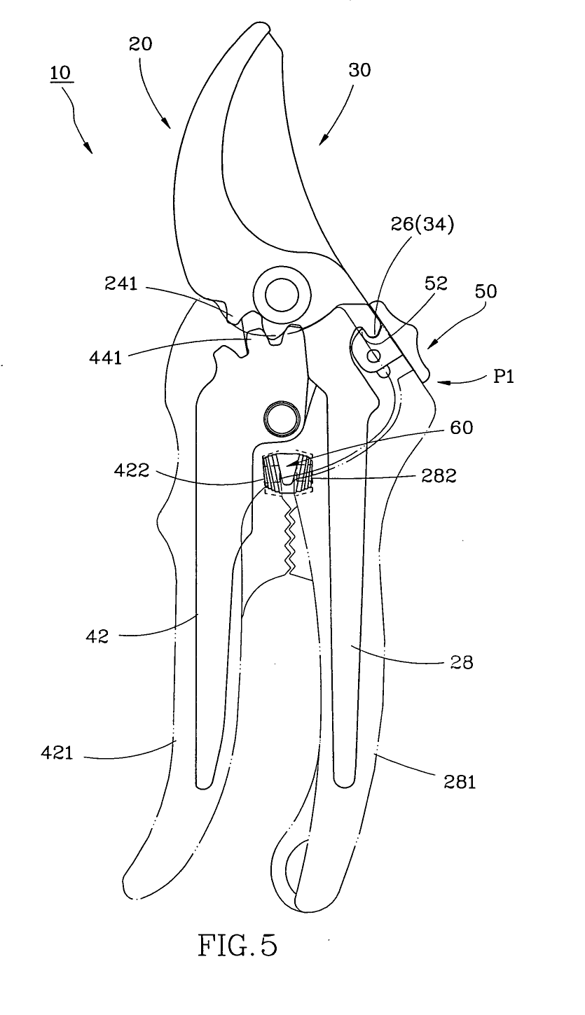

The limiter 50 is slidably mounted on a side of the upper part of the sheath 281 and provided with an engagement portion 52. The limiter 50 is movable relative to the first stop portion 26 of the stationary unit 20 and the second stop portion 34 of the movable unit 30 between an engagement position P1 where the engagement portion 52 is engaged with the first and second stop portions 26 and 34 as shown in FIG. 5 and a disengagement position P2 where the engagement portion 52 is disengaged with the first and second stop portions 26 and 34 as shown in FIG. 3 so as to control the enablement of movement action of the movable unit 30.

The spring member 60 is a compression spring, i.e. volute spring in this embodiment, which has to ends respectively coupled to the protrusion 282 of the sheath 281 and the protrusion 422 of the sheath 421 to provide an elastic force to support the second handle 42 and the first handle 28 away from each other.

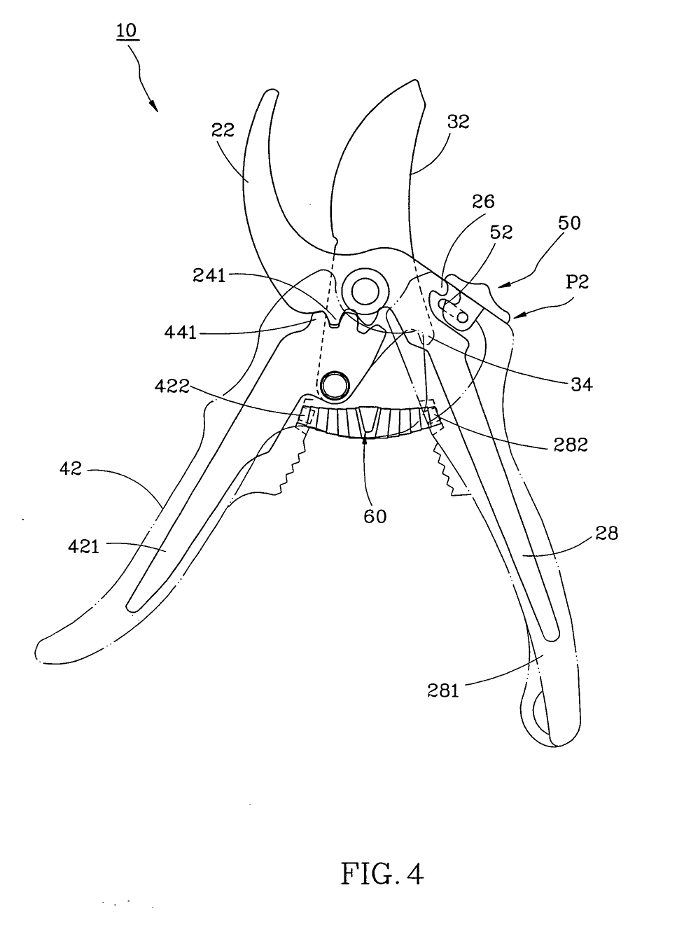

FIG. 4 shows the first blade portion 22 of the stationary unit 20 and the second blade portion 32 of the movable unit 30 are kept away form each other at normal status when the limiter is set at the disengagement position P2. If the user wants to use the flower shears 10, the user can press the sheath 281 covered on the first handle 28 and the sheath 421 covered on second handle 42 to pivotally move the second handle 42 toward the first handle 28, such that the second blade portion 32 of the movable unit 30 is driven by the second handle 42 through the engagement of the teeth 411 and 241 to move toward the first blade portion 22 of the stationary unit 20 so as to cut things (not shown) that are placed between the first and second blade portions, as shown in FIG. 3

When the cutting action is completed, the user can release the force acting on the first handle 28 and the second handle 42 such that the rebound force of the spring member 60 will force the second handle 42 to move away from the first handle 28, which in turn results in that the second blade portion 32 is moved in a reverse direction back to the initial position through the transmission of the meshed teeth 241 and 441, as shown in FIG. 4.

As indicated above, the first blade portion 22 and the second blade portion 32 are moved toward each other or moved away from each other to do cutting action at the time when the user presses or releases the first handle 28 and the second handle 42; therefore, the follower shears 10 of the present invention is convenient in operation.

As shown in FIG. 5, when the first blade portion 22 of the stationary unit 20 and the second blade portion 32 of the movable unit 30 are closed, the first stop portion 26 of the stationary unit 20 and the second stop portion 34 of the movable unit 30 are overlapped. Under this circumstance, the user can push the limiter 50 to the engagement position P1, such that the limiter 50 is engaged with the first stop portion 26 of the stationary unit 20 and the second stop portion 34 of the movable unit 30 to prohibit the movement of the movable unit 30 relative to the stationary unit 20, thereby preventing any accident that may be occurred due to the opened first and second blade portions 22 and 32.

As indicated above, the flower shears provided by the present invention achieves the following advantages.

1. Since the first transmission portion 24 and the second transmission portion 44 are engaged with each other by teeth 241 and 441, the cutting torque transmitted through the relative rotation of the engaged teeth 241 and 441 can be provided higher than the conventional flower shears, so that the flower shears 10 of the present invention is laborsaving in operation.

2. Because the spring member 60 provides the rebound force to return the movable unit 30 to the initial position, the flower shears 10 of the present invention is convenient in operation.

3. Because the limiter 50 can prohibit the relative movement of the stationary and movable units 20 and 30, the flower shears 10 of the present invention is safety in use and storage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flower shears comprising:
a stationary unit having a first blade portion at an upper part thereof, a first transmission portion at a middle part thereof, and a first handle at a lower part thereof;
a movable unit having a middle part pivotally connected to the stationary unit, and a second blade portion at an upper part thereof; and
a driving unit pivotally connected to a bottom end of the movable unit and provided with a second handle at a lower part thereof and a second transmission portion at a top end thereof engaged with the first transmission portion, such that the second blade portion of the moveable unit can be driven by the second handle through the engagement of first and second transmission portions to pivotally move toward the first blade portion of the stationary unit.

2. The flower shears as claimed in claim 1, wherein the stationary unit is provided with a first stop portion and the movable unit is provided with a second stop portion; the flower shears further comprises a limiter engageable with the first and second stop portions to prohibit the movement of the second blade portion of the moveable unit relative to the first blade portion of the stationary unit.

3. The flower shears as claimed in claim 1, further comprising a spring member set between the first handle and the second handle to support the first handle and the second handle away from each other.

4. The flower shears as claimed in claim 3, wherein the first handle and the second handle are respectively coupled with a sheath for holding by a user.

5. The flower shears as claimed in claim 4, wherein the spring member is a compression spring having two ends respectively coupled to a protrusion of each of the sheaths.

6. The flower shears as claimed in claim 1, wherein the first transmission portion and the second transmission portion are respectively provided with teeth meshed with each other.

7. The flower shears as claimed in claim 1, wherein the first handle and the second handle are respectively coupled with a sheath for holding by a user.
